(19) United States
(12) Patent Application Publication
(10) Pub. No.: US 2026/0245394 A1
(43) Pub. Date: Aug. 20, 2026

(54) Generative Artificial Intelligence Systems and Methods for Document Analysis and Comparison

(71) Applicant: Insurance Services Office, Inc., Jersey City, NJ (US)

(72) Inventors: Sundeep Sardana, Edison, NJ (US); Malolan Raman, Randolph, NJ (US); Maitri Shah, Jersey City, NJ (US); Raghava Thummapudi, Andhra Pradesh (IN); Muthu Lokesh Jothi, Chennai (IN); Joseph Lam, Centerport, NY (US); Sara Strohm, Bangor, ME (US); Colleen Martenson, Neenah, WI (US); Vaibhav Singh, Jersey City, NJ (US)

(73) Assignee: Insurance Services Office, Inc., Jersey City, NJ (US)

(21) Appl. No.: 19/545,636

(22) Filed: Feb. 20, 2026

Related U.S. Application Data
(60) Provisional application No. 63/760,910, filed on Feb. 20, 2025.

(51) Int. Cl. G06V 30/416; G06F 16/3329; G06F 16/34

(52) U.S. Cl. CPC G06V 30/416; G06F 16/33295; G06F 16/345

(57) ABSTRACT

Generative artificial intelligence systems and methods for document analysis and comparison are provided. The system includes a comparison processor and a comparison software engine executed by the comparison processor, which automatically analyzes and compares the contents of two documents or forms. The engine extracts sections from the documents using a plurality of trained artificial intelligence (AI) models, and performs mapping of the extracted document sections. The system them locates changes in the document, generates summaries of the changes, and tracks the changes in the documents so that they can be easily identified by a user.

### RELATED APPLICATIONS

The present application claims the benefit of U.S. Provisional Application Ser. No. 63/760,910 filed on Feb. 20, 2025, the entire disclosure of which is expressly incorporated herein by reference.

### BACKGROUND

### Technical Field

The present disclosure relates generally to the field of artificial intelligence. More specifically, the present disclosure relates to generative artificial intelligence systems and methods for document analysis and comparison.

### Related Art

In the insurance field, the ability to rapidly identify changes in documents such as insurance forms and other types of documents, is of significant importance. Traditionally, insurance professionals have manually compared documents to identify relevant changes across different documents, including different/updated versions of forms. This process is time-consuming and prone to error. Moreover, while there exist document comparison software applications, such applications do not effectively and efficiently perform comparisons of documents where context is especially important to perform efficient comparisons, such as insurance-related documents and forms.

The field of artificial intelligence, and in particular, generative artificial intelligence, is growing tremendously, and technologies in these areas are rapidly enhancing the speed with which useful data can be generated. However, such technologies have not yet effectively been incorporated into computer-based document comparison systems in the insurance context, where there is a significant need for improving the speed and accuracy of such software.

Accordingly, what would be desirable, but have not yet been provided, are generative artificial intelligence systems and methods for document analysis and comparison, which solve the foregoing and other needs.

### SUMMARY

The present disclosure relates to generative artificial intelligence systems and methods for document analysis and comparison. The system includes a comparison processor and a comparison software engine executed by the comparison processor, which automatically analyzes and compares the contents of two documents or forms. The engine extracts sections from the documents using a plurality of trained artificial intelligence (AI) models, and performs mapping of the extracted document sections. The system them locates changes in the document, generates summaries of the changes, and tracks the changes in the documents so that they can be easily identified by a user.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating the system of the present disclosure;

FIG. 2 is a flowchart illustrating processing steps carried out by the systems and methods of the present disclosure;

FIG. 3 is flowchart illustrating step 32 of FIG. 2 in greater detail;

FIG. 4 is a flowchart illustrating step 34 of FIG. 2 in greater detail;

FIG. 5 is a flowchart illustrating step 36 of FIG. 2 in greater detail;

FIG. 6 is a flowchart illustrating step 38 of FIG. 2 in greater detail;

FIG. 7 is a flowchart illustrating step 40 of FIG. 2 in greater detail;

FIG. 8 is a diagram illustrating software components for implementing the systems and methods of the present disclosure in a cloud computing environment; and

FIGS. 9-12 are screenshots illustrating various user interface screens generated by the systems and methods of the present disclosure.

### DETAILED DESCRIPTION

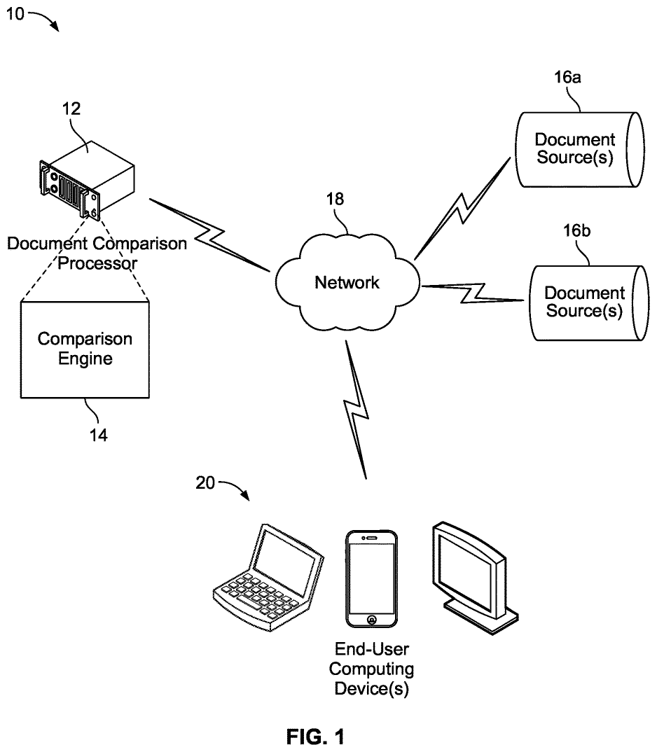

The present disclosure relates to generative artificial intelligence systems and methods for document analysis and comparison, as discussed in greater detail below in connection with FIGS. 1-12.

FIG. 1 is a diagram illustrating the system of the present disclosure, indicated generally at 10. The system 10 includes a document comparison processor 12 that executes a comparison software engine 14. The comparison engine 14 causes the processor to obtain two documents (or, forms) for comparison from a data source, such as the document source databases 16a-16b which could be in communication with the processor 12 via a network 18. Of course, the documents could also be local to the processor 12 (e.g., stored in a database of the processor 12), and/or supplied in real time to the processor 12 from a user device such as the end-user computing devices 20 (each of which could be in communication with the processor 12 via the network 18). The comparison processor 12 can be a suitable computer system including, but not limited to, a server, a cloud computing platform/service, a distributed processing system, a personal computer, a smart phone, a table computer, a microprocessor, a microcontroller, a graphics processing unit (GPU), a tensor processing unit (TPU), or other suitable computing device. The engine 14 could be embodied as non-transitory, computer-readable instructions stored in a non-transitory, computer-readable storage medium such as disk, memory, flash memory, or other suitable storage medium and executable by the processor 12. The engine 14 could be coded in any suitable high-or low-level computer programming language, including, but not limited to, C, C++, C #, Java, Javascript, Python, or other suitable programming language. Additionally, the engine 14 could be embodied as a custom hardware device, such as an application-specific integrated circuit (ASIC), field-programmable gate array (FPGA), or other suitable hardware device.

The network 18 could include, but is not limited to, a local area network (LAN), a wide area network (WAN), the Internet, a wireless (e.g., cellular data) network, or other suitable communications network. The document sources 16a-16b could share information with the processor 12 and comparison engine 14 using suitable data exchange protocols and/or formats, such as extensible markup language (XML), one or more application programming interface (API) calls/requests, or other protocols/formats.

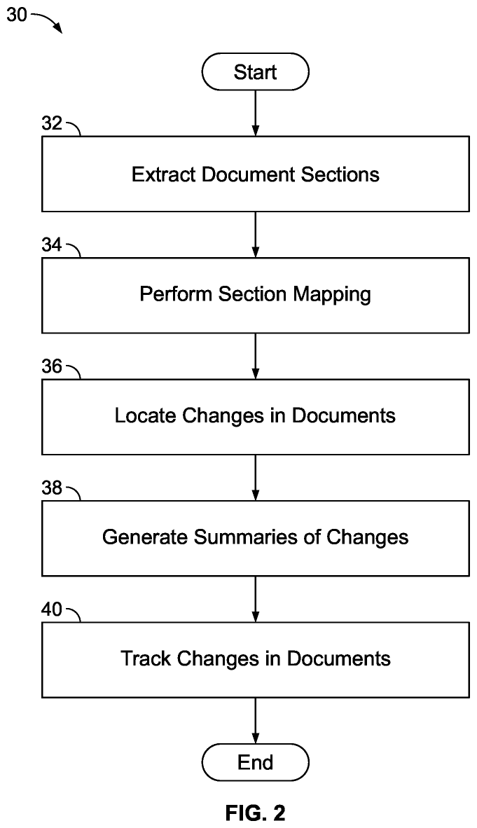

Output generated by the comparison engine is accessible by one or more end-user computing devices 20, which could include, but is not limited to, personal computers, laptop computers, servers, smart phones, etc. The output of the comparison engine 14 could be accessible on such devices using one or more software applications (“apps”) executed by the devices 20, and/or in a web-based interface that is hosted by the processor 12 or other device and accessible using a web browser executing on the devices 20. Still further, it is noted that the comparison engine 14 need not be executed by the processor 12, but could instead be stored on and executed by one or more of the end-user computing devices 20. The features of, and functions performed by, the system 10 are discussed in greater detail in connection with FIGS. 2-12.

FIG. 2 is a flowchart, indicated generally at 30, illustrating processing steps carried out by the systems and methods of the present disclosure. In step 32, the system extracts document sections from documents to be analyzed or compared. Next, in step 34, the system performs section mapping wherein the sections that have been extracted from the documents are mapped to each other and/or aligned. In step 36, the system locates changes in the documents using the extracted and mapped document sections. In step 38, the system generates one or more summaries of the located changes in the documents. Finally, in step 40, the system tracks changes in the documents and indicates them to the user (e.g., graphically, in a graphical user interface screen, or in a file transmitted to the user or to another computer system).

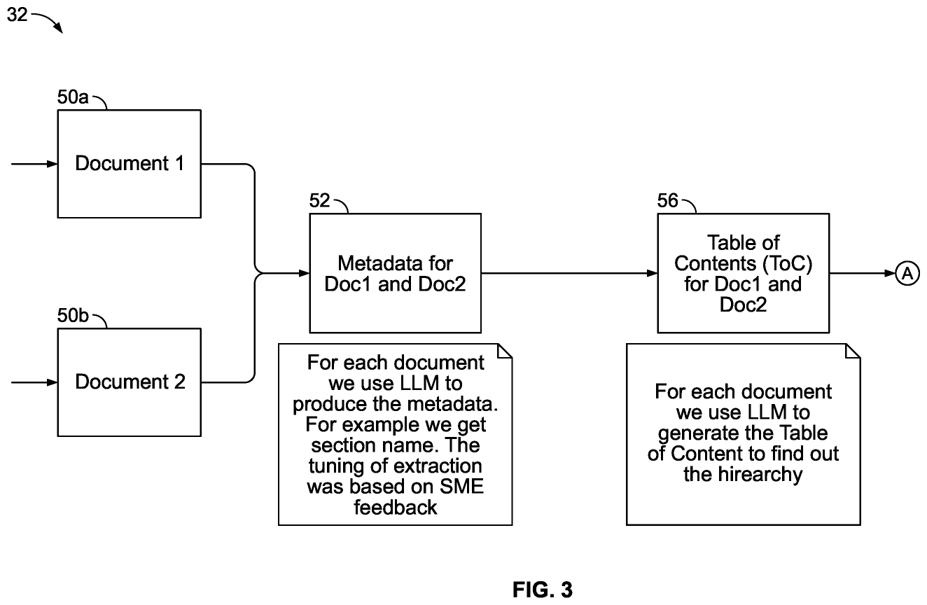

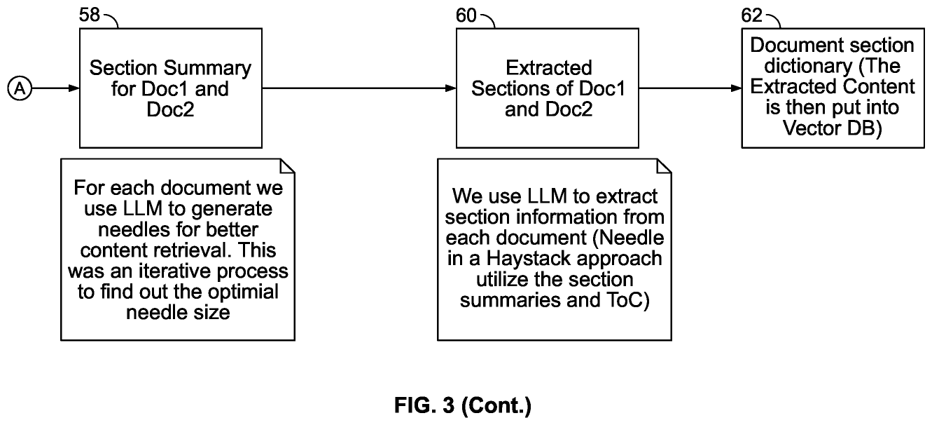

FIG. 3 is flowchart illustrating step 32 of FIG. 2 in greater detail. In step 52, the system retrieves two documents 50a, 50b for which comparison and/or analysis is desired. The documents 50a, 50b could be supplied by the document sources (databases) 16a-16b of FIG. 1, or from some other data source. In step 52, the system extracts metadata from the documents such as, but not limited to, section names, heading names, etc., using a guided trained large language model (LLM) that has been calibrated using Retrieval-Augmented Generation (RAG) techniques to identify such document metadata. Next, in step 56, the system creates a table of contents (ToC) for each document using a second guided LLM which processes the document metadata to create the ToCs. The ToCs indicate the hierarchy of each document and assist the system in automatically identifying changes in the documents. In step 58, the system generates a section summary for each document using a third guided LLM which processes the ToCs and the metadata generated by the first and second LLMs to generate the section summaries. This is accomplished by the third LLM generating a precise content summary which is tuned using a “needle in the haystack” approach that is designed to improve the accuracy of the LLM. Next, in step 60, the system extracts the section information from the documents using the section summaries and the ToCs using a fourth LLM. Finally, in step 62, the system creates a document section dictionary for each document, which could be stored in a database such as a vector database.

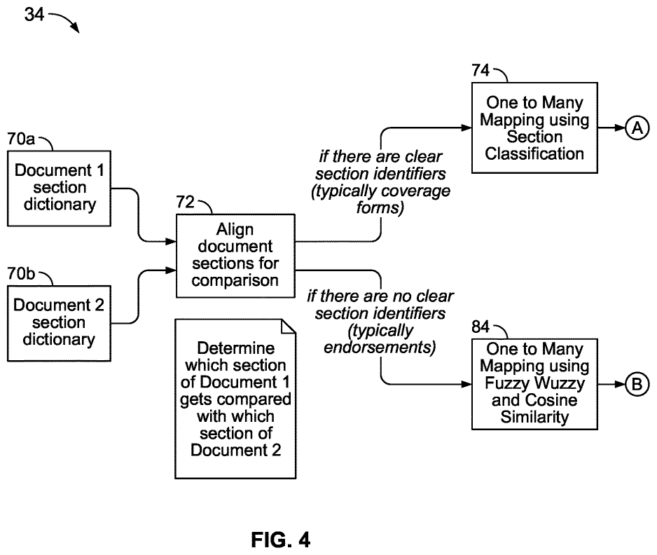

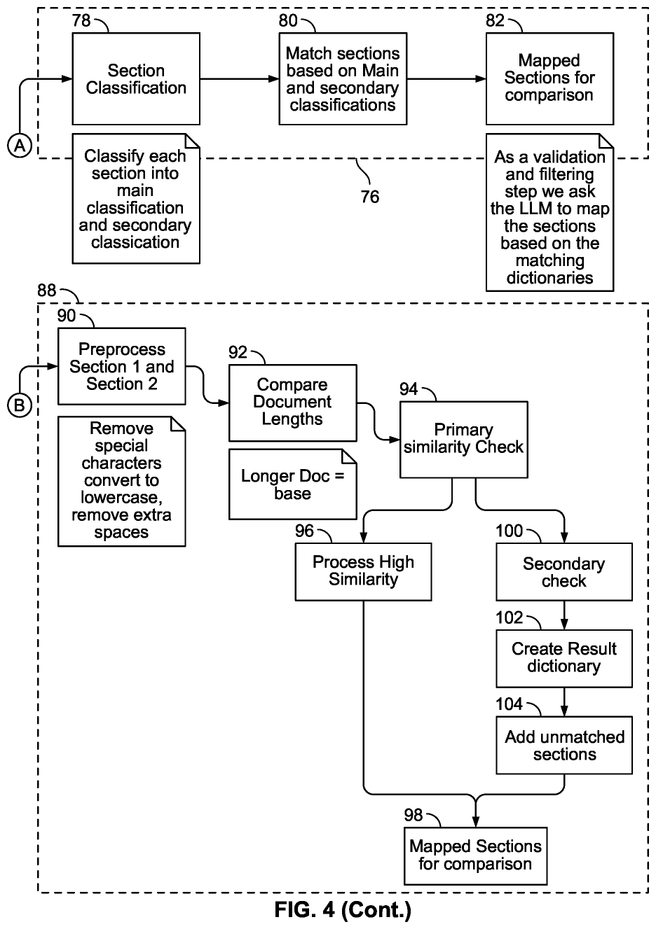

FIG. 4 is a flowchart illustrating step 34 of FIG. 2 in greater detail. In step 72, the system receives two document summary dictionaries 70a-70b generated in step 32 discussed above, and aligns the document sections for comparison. In this step, the system determines which section of one document is compared with a corresponding section of the second document. If there are clear section identifiers present in the documents (which, for example, typically occurs if the documents are standard insurance coverage forms), step 74 occurs, wherein the system performs a one-to-many mapping of the two documents using section classification, followed by processing phase 76. In step 78, section classification occurs, wherein the system classifies each section into a main classification and a secondary classification using a trained LLM. Next, in step 80, the system matches sections based on the main and secondary classifications. In step 82, the system generates mapped sections that will be used by the system for comparison. In this step, and LLM can be utilized to map sections based on the matching dictionaries in order to perform validation and filtering. It is noted the section classification performed in phase 76 classifies each section into main and secondary classes, including, but not limited to, declarations, insuring agreement, definitions, coverages, limits of insurance, deductibles, additional insureds, loss conditions, supplementary amounts, payments, and other classes.

If, in step 72, the system determines that there are no clear sections identified in the documents (which can happen with insurance endorsements or similar documents), step 84 and processing phase 88 occur. In step 84, the system performs one-to-many mapping using a string matching algorithm such as the “FuzzyWuzzy” algorithm or other similar string matching algorithm, and a cosine similarity measurement. In step 90, the system preprocesses sections of the two documents (Sections 1 and 2). In this step, the system removes special characters, converts characters to lower case, and removes extra spaces. In step 92, the system compares document lengths, wherein the longer document length is set to a base value. In step 94, the system performs a primary similarity check between the document sections using fuzzy string matching. This step could involve combining token ratios (such as sort and set ratios), performing an initial similarity assessment using the combined token ratios, and calculating an average score which can indicate an initial match. Then, in step 96, the system processes the high-level similarity, and in step 98, the sections are mapped for comparison.

In step 100, the system performs a secondary check of the sections, which involves calculating a cosine similarity for the sections (including calculating a term frequency-inverse document frequency (TF-IDF) product for the sections and performing a vector comparison of the sections). In step 102, the system creates a result dictionary, and in step 104, the system adds unmatched sections. Finally, step 98, discussed above, occurs.

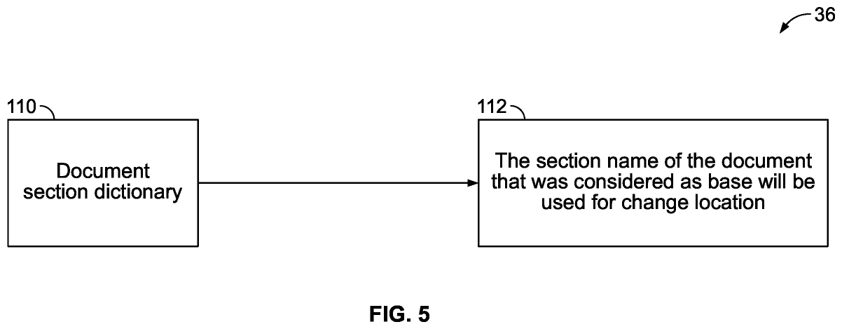

FIG. 5 is a flowchart illustrating step 36 of FIG. 2 in greater detail. In step 110, the system obtains the document section dictionary discussed in connection with FIG. 3 above. Then, in step 112, the system identifies a section name of the document that was considered the base as the location of a change in the document.

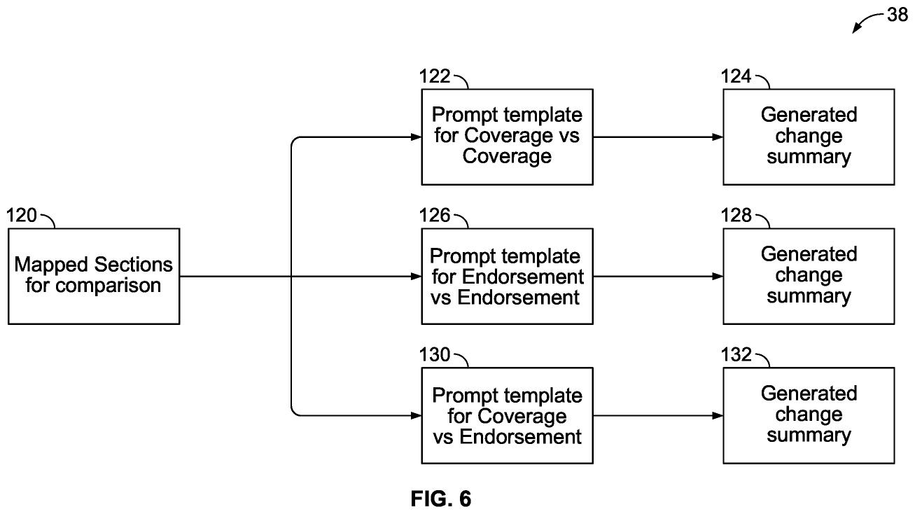

FIG. 6 is a flowchart illustrating step 38 of FIG. 2 in greater detail. In step 120, the system identifies mapped sections that are to be used for comparison purposes. In steps 122, 126, and 130, one or more pre-defined, tuned, generative AI prompt templates are selected based on the mapped sections that will be compared, including a first prompt template 122 tuned for comparing coverages against coverages, a second prompt template 128 tuned for comparing endorsements against endorsements, and a third prompt template 130 tuned for comparing coverages against endorsements. These templates, along with the mapped sections for comparison, are then fed to a generative AI platform, which then generates summaries 124, 128, and 132 based on the templates and the mapped sections fed to the generative AI platform.

The prompt template 122 could include the following parameters/attributes:

### Tone

Refrain from using the word “clarity” and all its forms, including “clarifying” and “clarification,” in change summaries.
Ensure that the word “expanded” is not used in change summaries instead use “revised” in change summaries.

### Summary Style

Present each change summary separated with pipe symbol (|) in the following detailed format:
   |[Abbreviated Breadcrumb location(subsection id>nested subsection id)]|:|In [precise paragraph reference] of [Section] in [Form Number with complete paragraph reference], [detailed description of change]. [Quote the exact text changed from <del> tags, if applicable] to [Quote the exact text in <ins> tags, if applicable].

For changes involving paragraph structure or hierarchy:
Include: “Previously [complete paragraph reference] in [original form number], now [complete paragraph reference] in [new form number]”

For sub-paragraph changes:

Include: “This change affects the following hierarchy: [list complete paragraph structure from parent to child]”

The prompt templates 126 and/or 130 could include the following parameters/attributes:

### Tone

Identify changes in the overall structure of the document, such as paragraph arrangements and sub-paragraph renumbering.
If paragraph identifiers have changed (e.g., Paragraph H in {0} is now Paragraph I in {1}), highlight these changes clearly as structural changes.
Highlight any additions, deletions, reordering, or renumbering of content.
Focus on changes like a sub-paragraph being moved or a new sub-paragraph being inserted.

### Summary Style

Present change summary to help them to understand the significant changes made in the {1}'s paragraph/sub-paragraphs by comparing with {0}'s paragraph

Make sure to follow the language and formatting as mentioned in <example> tags.

Here are examples within <example> tags on how to provide change summary:

### Example1

H: Provide the Changed Summary for the given paragraph, “XY12345678” and “XY12345687”.
“Paragraph”: “D”
“XY12345678”: “D. We will not pay under Coverage A, B or C of this endorsement for:
   1. Enforcement of or compliance with any ordinance or law which requires the demolition, repair, replacement, reconstruction, remodeling or remediation of property due to contamination by ““pollutants”” or due to the presence, growth, proliferation, spread or any activity of ““fungus””, wet or dry rot or bacteria; or
“Changed Summary”: “|The paragraph identifiers were updated from D.1 and D.2 in XY12345678 to A.6.a and A.6.b in XY12345687.
         |The content of paragraph A.6. in XY12345687 has been updated to broaden the exclusion. Removing the exlcusion specific to Coverage A, B, C of this endorsement referenced in CP04051012 and has applied the exlusion to the whole endoresement in XY12345687.
         |The language remains the same between D.1 and D.2 of XY12345678 and A.6.a and A.6.b of XY12345687.”

### /example1

Of course, other types of prompt templates could be utilized without departing from the spirit or scope of the present disclosure.

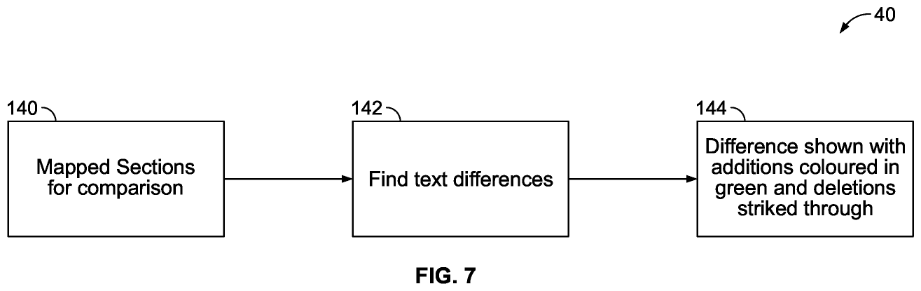

FIG. 7 is a flowchart illustrating step 40 of FIG. 2 in greater detail. In step 140, the system identifies mapped sections for comparison. Next, in step 142, the system finds text differences in the mapped sections. Finally, in step 144, the system indicates the differences using suitable colors and/or indicia. For example, the differences in the sections can be shown with additions colored in green and deletions struck through, and such differences can be graphically shown to the user in a graphical user interface screen and/or in an output file.

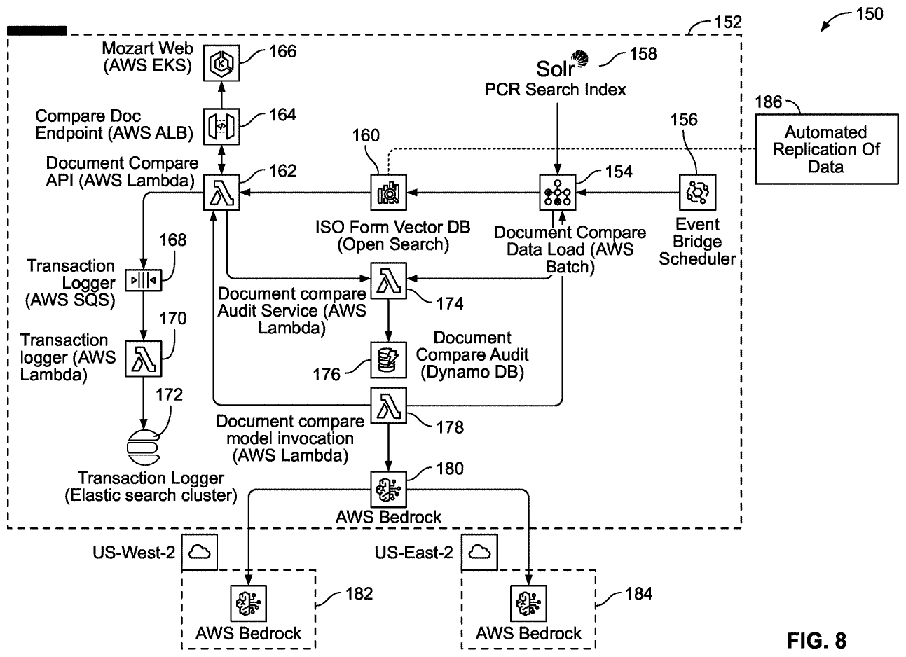

FIG. 8 is a diagram illustrating software components for implementing the systems and methods of the present disclosure in a cloud computing environment, indicated generally at 150. The system could execute on a first cloud computing instance 152, and could include a document comparison data loading process 154, an event bridge scheduler 156, a search query index 158, a vector database 160, a document comparison module 162, a document comparison endpoint 164, a web interface 166, transaction loggers 168-172, document comparison audit services 174-176, document comparison model invocation module 178, a generative AI application 180, and one or more distributed generative AI applications 182-184. Data stored in the vector database 160 could be replicated by module 186 to one or more other cloud computing instances, for data backup and reliability purposes. Of course, the cloud computing components discussed above in connection with FIG. 8 are illustrative only, and other cloud computing components could be utilized without departing from the spirit or scope of the present disclosure.

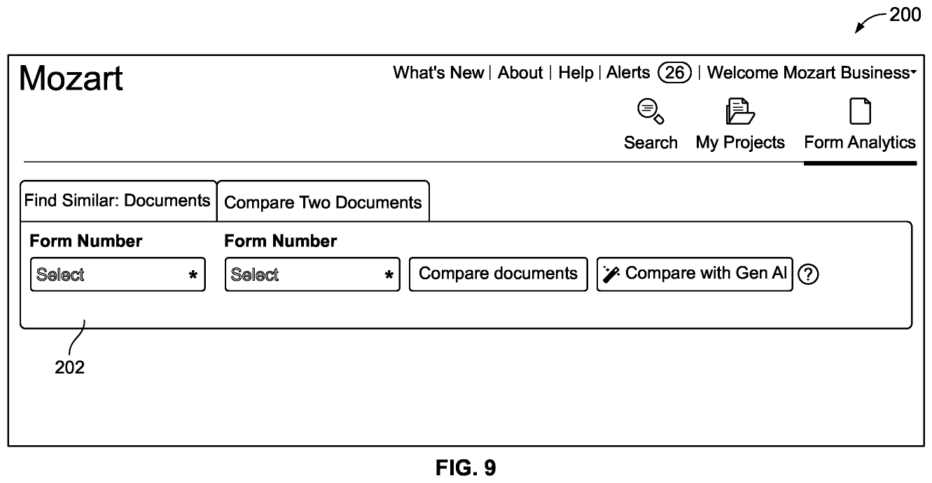

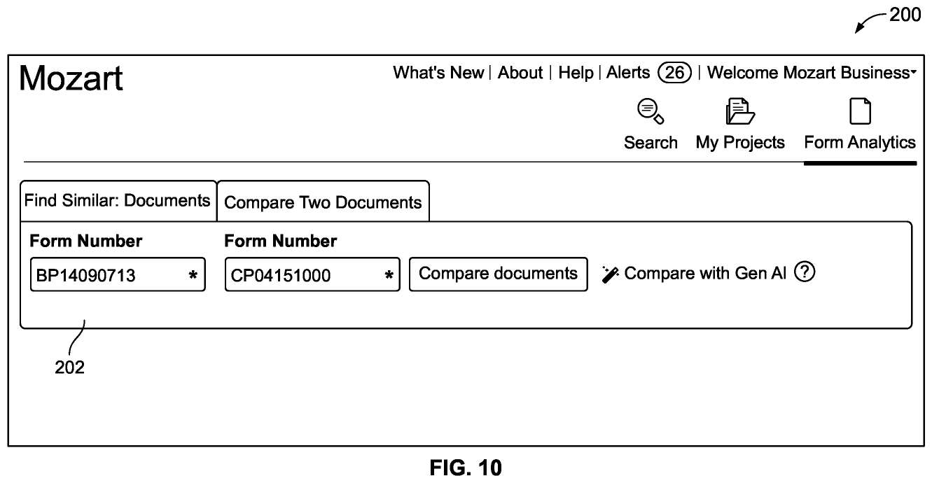

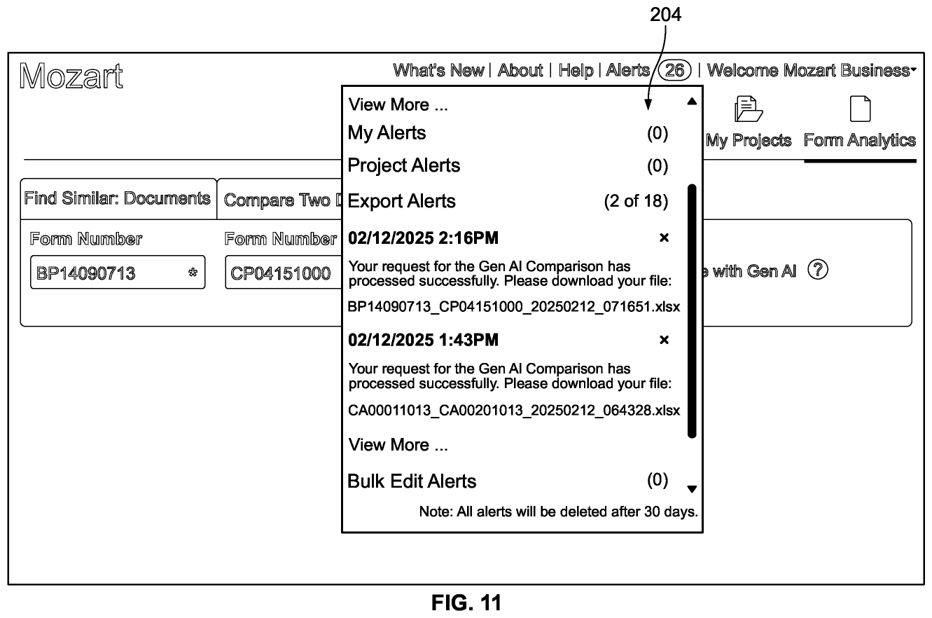

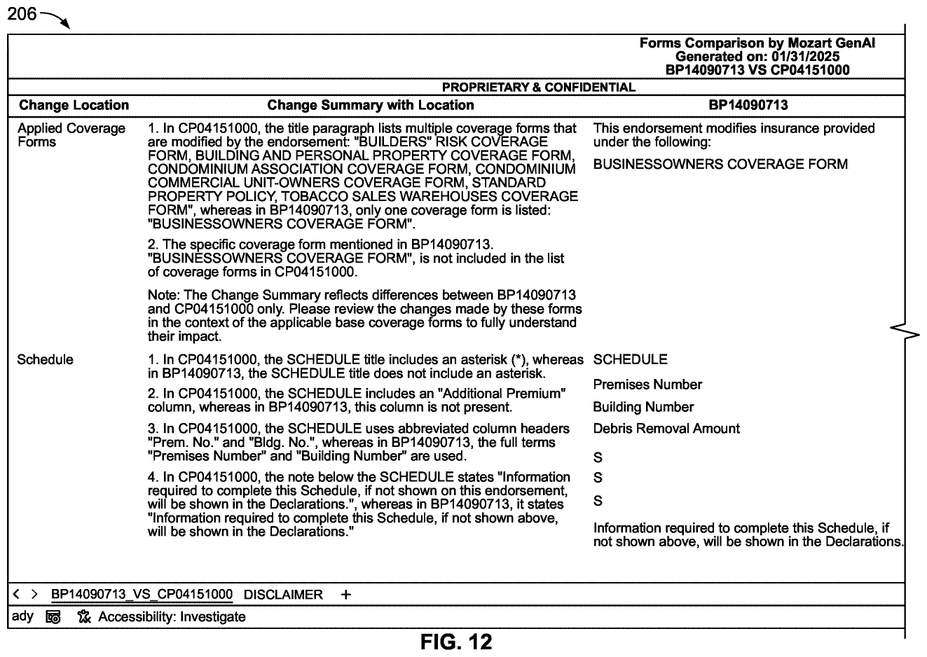

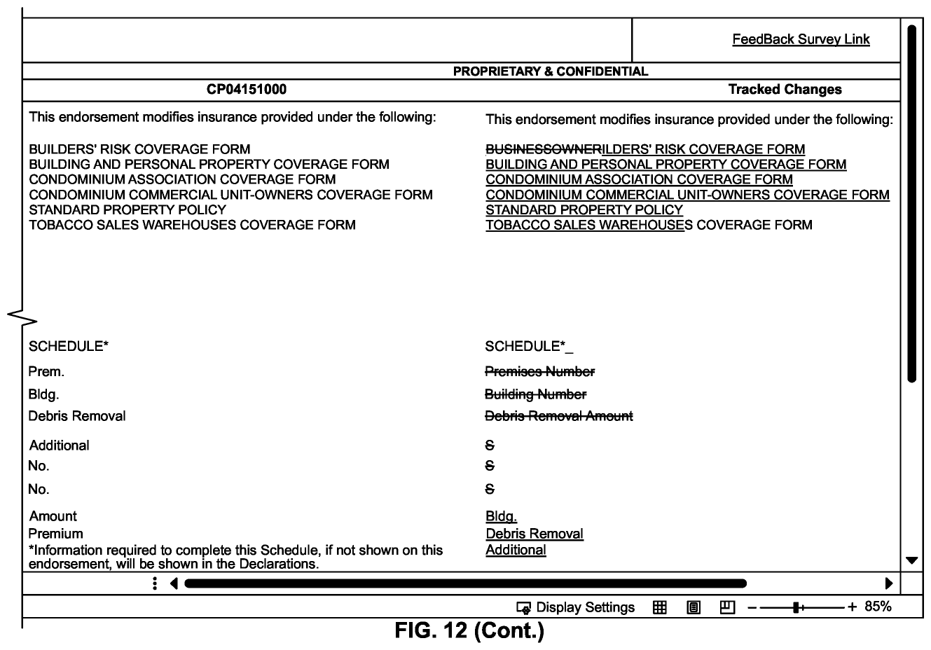

FIGS. 9-12 are screenshots illustrating various user interface screens generated by the systems and methods of the present disclosure. As shown in FIG. 9, the system generates and displays a first screen 200 which includes an input panel 202 that allows the user (e.g., a user of one or more of the end-user computing devices 20 of FIG. 1) to identify two documents or forms for which comparison is desired. As illustrated in FIG. 10, the user identifies a first document (Form Number BP14090713) to be compared against a second document (Form Number CP04151000). The user can then click one of the buttons shown in FIG. 10 to initiate the comparison of the identified documents/forms. As shown in FIG. 11, the system can generate and display one or more alerts 204, such as whether the comparison processes is executing successfully by the system, or of there are processing/comparison errors. The results of the comparison are shown in the screen 206 of FIG. 12, wherein changes in the selected documents/forms are identified using underlining or strike-through, and/or using different type fonts or colors.

It is noted that the various LLMs discussed herein could include the Anthropic Claude Sonnet LLM (which could be used for inferencing (e.g., inferring document sections)), and the Amazon Titan Text LLM (which could be used for creating embeddings). Of course, other types of LLMs could be utilized without departing from the spirit or scope of the present disclosure. Advantageously, the processing steps discussed herein in connection with FIGS. 2-7 and the accompanying LLMs and generative AI components significantly improve the speed and accuracy with which a computer system can perform document comparisons. Especially important is the ability of the system to perform context-sensitive comparisons (which are enabled by the processing steps discussed herein and the associated LLMs, tuned prompt templates, and other components) of documents/forms, in a manner that existing software-based comparison systems cannot efficiently perform such comparisons, with high degrees of accuracy.

Having thus described the systems and methods in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

What is claimed is:

1. A generative artificial intelligence system for document analysis and comparison, comprising:
a document comparison processor; and
a comparison software engine executed by the document comparison processor, the engine causing the processor to:
receive a plurality of documents for comparison from a data source;
process the plurality of documents using a first large language model (LLM) trained to extract sections from documents, the first LLM extracting a plurality of sections from the plurality of documents;
map the plurality of sections to each other using a second large language model (LLM) trained to map document sections;
process the plurality of documents to locate changes in the plurality of documents using the extracted and mapped plurality of sections; and
generate one or more summaries of changes in the documents using the located changes in the documents and a plurality of generative artificial intelligence (AI) prompt templates selected based the mapped plurality of sections mapped by the second LLM.

2. The system of claim 1, wherein the engine causes the processor to align the plurality of sections.

3. The system of claim 1, wherein the engine causes the processor to track changes in the documents and indicate the tracked changes to the user.

4. The system of claim 1, wherein the first LLM extracts document metadata from the plurality of documents.

5. The system of claim 4, wherein the first LLM is calibrated using at least one retrieval-augmented generation (RAG) techniques to identify the document metadata.

6. The system of claim 4, wherein the engine causes the processor to generate a table of contents for each of the plurality of documents from the document metadata using a third large language model (LLM).

7. The system of claim 6, wherein the engine causes the processor to generate a section summary for each of the plurality of documents using a fourth large language model (LLM), the fourth LLM processing the document metadata identified by the first LLM and the table of contents generated by the third LLM.

8. The system of claim 7, wherein the engine causes the processor to extract section information from the plurality of documents using a fifth large language model (LLM), the fifth LLM processing the section summaries generated by the fourth LLM.

9. The system of claim 1, wherein the second LLM maps the plurality of sections to each other using a main classification and a secondary classification.

10. The system of claim 9, wherein the engine causes the processor to map the plurality of sections to each other using a string matching algorithm and a cosine similarity measurement.

11. The system of claim 1, wherein plurality of AI prompt templates include a first template tuned for comparing insurance coverages, a second template tuned for comparing insurance endorsements, and a third template tuned for comparing insurance coverages against insurance endorsements.

12. A generative artificial intelligence method for document analysis and comparison, comprising:
receiving by a document comparison processor a plurality of documents for comparison from a data source;
processing the plurality of documents using a first large language model (LLM) trained to extract sections from documents, the first LLM extracting the plurality of sections from the plurality of documents;
mapping the plurality of sections to each other using a second large language model (LLM);
processing the plurality of documents to locate changes in the plurality of documents using the extracted and mapped plurality of sections; and
generating one or more summaries of changes in the document using a plurality of generative artificial intelligence (AI) prompt templates selected based the mapped plurality of sections mapped by the second LLM.

13. The method of claim 12, further comprising aligning the plurality of sections.

14. The method of claim 12, further comprising tracking changes in the documents and indicating the tracked changes to the user.

15. The method of claim 12, wherein the first LLM extracts document metadata from the plurality of documents.

16. The method of claim 15, wherein the first LLM is calibrated using at least one retrieval-augmented generation (RAG) techniques to identify the document metadata.

17. The method of claim 11, further comprising generating a table of contents for each of the plurality of documents from the document metadata using a third large language model (LLM).

18. The method of claim 17, further comprising generating a section summary for each of the plurality of documents using a fourth large language model (LLM), the fourth LLM processing the document metadata identified by the first LLM and the table of contents generated by the third LLM.

19. The method of claim 18, further comprising extracting section information from the plurality of documents using a fifth large language model (LLM), the fifth LLM processing the section summaries generated by the fourth LLM.

20. The method of claim 12, further comprising mapping the plurality of sections to each other using a main classification and a secondary classification.

21. The method of claim 20, further comprising mapping the plurality of sections to each other using a string matching algorithm and a cosine similarity measurement.

22. The method of claim 12, wherein plurality of AI prompt templates include a first template tuned for comparing insurance coverages, a second template tuned for comparing insurance endorsements, and a third template tuned for comparing insurance coverages against insurance endorsements.
